(19) United States
(12) Patent Application Publication
(10) Pub. No.: US 2004/0060008 A1
(43) Pub. Date: Mar. 25, 2004

(54) Displaying statistical data for a web page by dynamically modifying the document object model in the HTML rendering engine

(76) Inventor: John Marshall, Santa Cruz, CA (US)

Correspondence Address: LAW OFFICE OF CHARLES E. KRUEGER, P.O. BOX 5607, WALNUT CREEK, CA, 94596-1607, US

(21) Appl. No.: 10/601,054

(22) Filed: Jun. 20, 2003

Related U.S. Application Data
(63) Continuation-in-part of application No. 10/348,211, filed on Jan. 16, 2003.
(60) Provisional application No. 60/350,126, filed on Jan. 18, 2002.
(60) Provisional application No. 60/390,514, filed on Jun. 21, 2002.

(51) Int. Cl. G06F 15/00

(52) U.S. Cl. 715/513

(57) ABSTRACT

A system and method for graphicaly displaying a statistic related to a displayed web page element as an overlay in close proximity to the web page element.

### CROSS-REFERENCES TO RELATED APPLICATIONS

This application is a continuation-in-part of U.S. patent application Ser. No. 10/348,211 entitled SYSTEM AND METHOD FOR REPORTING USER INTERACTION WITH A WEB SITE filed Jan. 16, 2003, which is hereby incorporated by reference for all purposes, which claims priority from a provisional patent application entitled SYSTEM AND METHOD FOR REPORTING USER INTERACTION WITH A WEB SITE, A/N No. 60/350,126 filed Jan. 18, 2002, and this application also claims priority from a provisional patent application entitled DISPLAYING STATISTICAL DATA FOR A WEB PAGE BY DYNAMICALLY MODIFYING THE DOCUMENT OBJECT MODEL IN THE HTML RENDERING ENGINE, A/N No. 60/390,514 filed Jun. 21, 2002, which is hereby incorporated by reference for all purposes.

### BACKGROUND OF THE INVENTION

A website is stored on a central computer known as the web server. Users around the world equipped with web browser software can enter the name of the website (URL) and see the pages comprising the site.

By clicking HyperLinks within each page on the site the user navigates from page to page. A typical web page shows the links underlined.

As user clicks on the links the web server records information into a file known as the log file. The specific format and information written to the file varies slightly according to the web server software being used and the way the web site is structured, but the following information at least is recorded:

IP Address of client (user)

Date & time

Type of request

Type of response from server

URL requested

Referring URL

Cookie information from user

Type of browser used on client

Log file analysis

Software programs exist that take the log file produced from the server and generate statistical information. These programs display, for example, the average length of time each user spends on each page, or the path they take from page to page.

Many of these existing analysis programs are hard to use. Although they display the data gathered from the log file, it is not displayed in the context of the website to which it relates. It is very hard for the user to understand which pages on his website are successful (people stay on that page for long periods).

However effective and efficient techniques for displaying statistics are not currently available.

### BRIEF SUMMARY OF THE INVENTION

In a first embodiment of the invention, a user is performing analysis of a website using software that takes the statistical data about the site, and maps this data on top of the actual website. This could take the form, for example, of that shown in FIG. 1B. The user sees the page and overlaid on the top are bars that represent statistical data about the page itself, such as the number of users clicking on any element. Other graphs and charts besides bars could be used.

In another embodiment of the invention, a technique is described that permits the user to simultaneously view the website and the statistics, without requiring any modifications to the actual live website itself. The method can join these two disparate sources of data and display them simultaneously with no operator intervention.

Other features and advantages of the invention will be apparent in view of the following detailed description and appended drawings.

### BRIEF DESCRIPTION OF THE DRAWINGS

FIG. 1A depicts a prior art web page;

FIG. 1B is an example of how the statistics might be viewed according to an embodiment of the invention, overlaid on a web page;

FIG. 2 is a block diagram of the processes and software components involved;

FIG. 3 shows the typical hierarchy of objects representing the HTML page, known as the Document Object Model (DOM); and

FIG. 4. shows an example DOM hierarchy after the charts are added using this technique

### DETAILED DESCRIPTION OF THE INVENTION

The invention will now be described with reference to specific embodiments by way of example not limitation. In the drawings like or similar parts in different views have the same reference number. In the following the various embodiments of the invention are referred to as Rorschach.

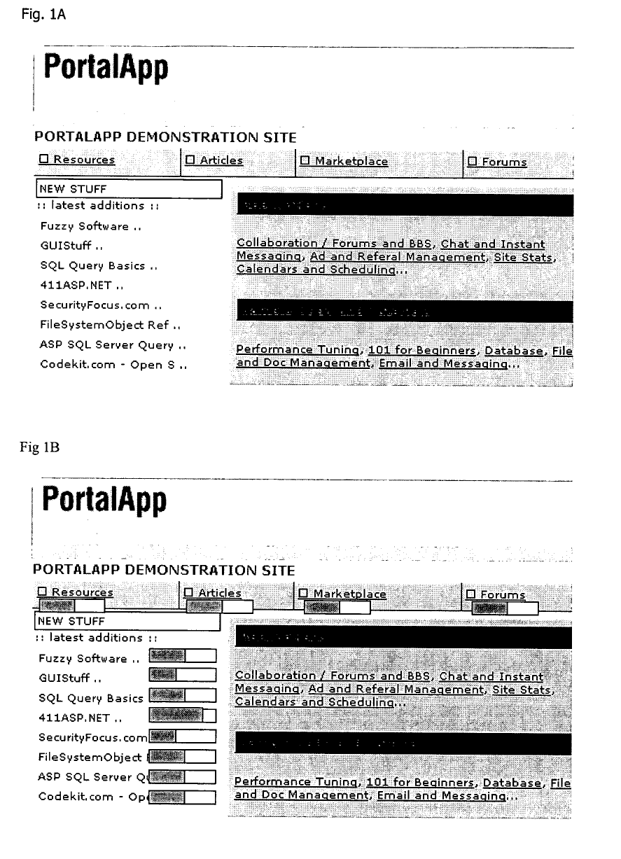

FIG. 1A depicts a typical web page display and FIG. 1B depicts the function of an embodiment of the invention which displays graphs as overlays depicting the number of users clicking on each element displayed on the web page.

First Embodiment:

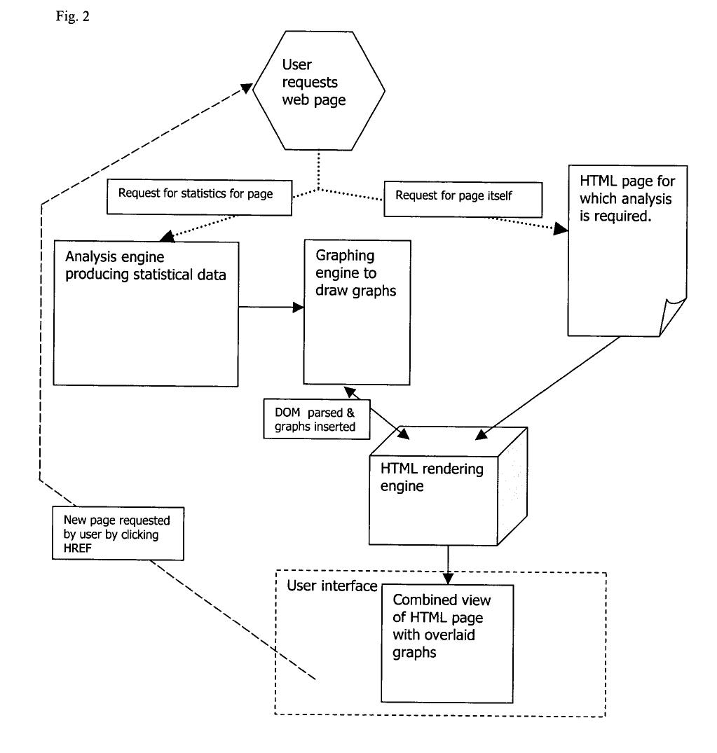

The HTML data for the page presented to the operator is rendered by an HTML rendering engine, shown in FIG. 2. Also shown is the process by which statistical data for this page is extracted from a database, and can then be represented as a series of charts or graphs.

This engine is external to Rorschach. It is typically a component of an external web browser or HTML editing tool. Rorschach integrates with the rendering engine, appearing to the operator as a single entity.

Rorschach determines the URL of the page being viewed via the engine. Rorschach dynamically pulls the relevant statistical data for the page according to this URL and the statistics available for the page. It does this by integrating directly with the rendering engine through suitable programming interfaces provided by the rendering engine

Rorschach now has the statistics data for the page, and the page itself that this data relates to. It parses the Document Object Model (DOM) for the page and on the-fly works out which elements in the page are objects for which it has statistical data available. Knowing the location, type and other details of each element it can construct suitable graphs and charts that convey information to the user, such as the number of website visitors that click on each element. It then modifies the DOM of the page in such a way that the statistics for the objects appear overlaid or in close proximity to the objects themselves.

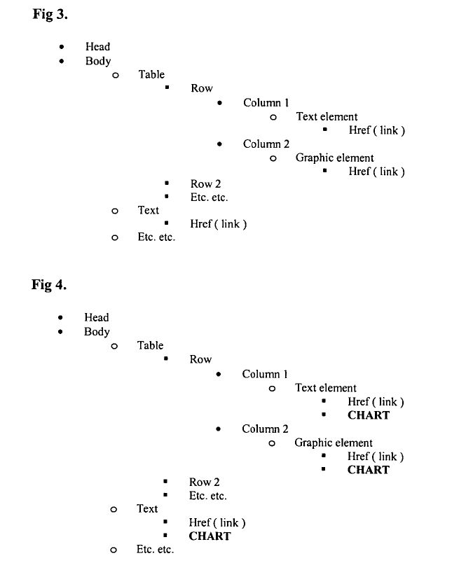

FIG. 3 shows the document object model (DOM) before this operation.

FIG. 4 shows one example of the document object model (DOM) after it has been modified. The items in bold represent the bar charts inserted such that they appear near the data.

Another possibility would be to modify the DOM such that the statistical data is inserted at the end of the hierarchy, but in such a way that the graphs or charts still appear overlaid over the hyperlinks correctly.

The invention may be implemented as program code, stored on a computer readable medium, that is executed by a digital computer. The computer readable medium may include, among other things, magnetic media, optical media, electromagnetic fields encoding digital information, and so on.

The invention has now been described with reference to the preferred embodiments. Alternatives and substitutions will now be apparent to persons of skill in the art. Accordingly, it is not intended to limit the invention except as provided by the appended claims.

What is claimed is:

1. A method for displaying statistics, such as numbers of users, date and time of access, referring URL, and so on, pulled from a web page and stored, said method comprising the steps of:
parsing the dynamic object model (DOM) of the web page and dynamically determining which elements of the page are objects that have statistics available;
determining the location and type of each element which is an object having statistics available;
for a first element which is an object having statistics available, constructing a first graphic object that conveys information to a user based on statistical information available for the first object; and
modifying the DOM of the web page so that the first graphic object is displayed as an overlay to the web page in close proximity to the first graphic object.

2. The method of claim 1 where the step of constructing further comprises:
constructing a graph depicting an available statistical quantity for the first element.

3. The method of claim 1 where the step of constructing further comprises:
constructing a chart depicting an available statistical quantity for the first element.

4. A computer program executed in a processor in a system for displaying statistics, such as numbers of users, date and time of access, referring URL, and so on, pulled from a web page and stored, said computer program product comprising:
a computer usable medium having computer readable program code physically embodied therein, said computer program product further comprising:
computer program code for causing the processor to parse the dynamic object model (DOM) of the web page and to dynamically determine which elements of the page are objects that have statistics available;
computer program code for causing the processor to determine the location and type of each element which is an object having statistics available;
computer program code for causing the processor to construct a first graphic object, for a first element which is an object having statistics available, that conveys information to a user based on statistical information available for the first object; and
computer program code for causing the processor to modify the DOM of the web page so that the first graphic object is displayed as an overlay to the web page in close proximity to the first graphic object.

5. The computer program product of claim 4 where the computer program code for causing the processor to construct further comprises:
computer program code for causing the processor to construct a graph depicting an available statistical quantity for the first element.

6. The computer program product of claim 4 where the computer program code for causing the processor to construct further comprises:
computer program code for causing the processor to construct a chart depicting an available statistical quantity for the first element.
